(19) United States
(12) Patent Application Publication
(10) Pub. No.: US 2023/0353973 A1
(43) Pub. Date: Nov. 2, 2023

(54) IDENTIFYING WIRELESS DEVICES THAT HAVE RELATIONSHIPS WITH EACH OTHER

(71) Applicant: Telefonaktiebolaget LM Ericsson (publ), Stockholm (SE)

(72) Inventors: Elena FERSMAN, Stockholm (SE); Yifei JIN, Solna (SE); Rafia INAM, Västerås (SE)

(21) Appl. No.: 17/925,031

(22) PCT Filed: May 12, 2020
(86) PCT No.: PCT/EP2020/063212

§ 371 Date: Nov. 14, 2022

(51) Int. Cl. H04W 4/02; H04W 4/70

(52) U.S. Cl. CPC H04W 4/023; H04W 4/70

(57) ABSTRACT

According to an aspect, there is provided a method of operating a data analysis node in a communication network, the method includes receiving, from a location information management node in the communication network, behaviour information relating to an operational state and/or configuration of a first wireless device, and a request for information identifying wireless devices that have a relationship with the first wireless device; analysing the received behaviour information for the first wireless device and behaviour information for one or more other wireless devices to identify one or more wireless devices that have a relationship with the first wireless device; and sending, to the location information management node, relationship information includes an identity of the one or more wireless devices that are identified as having a relationship with the first wireless device.

### TECHNICAL FIELD OF THE INVENTION

This disclosure relates to methods and apparatus in communication networks, and in particular to methods and apparatus for enabling relationships between wireless devices to be identified.

### BACKGROUND OF THE INVENTION

Location-based service (LBS) technologies are used in many different applications such as navigation, search and advertising, infotainment, location tracking, games and augmented reality. Many different software applications have been developed that use LBS to share current locations, such as Find My Friends, Pokémon Go, Uber, Foursquare, etc. These are mostly used for finding restaurants, finding friends close by, checking public transport, finding recommendations, advertisements or discounts when you pass by shops, etc. The wireless devices (also referred to as mobile devices, user devices, and User Equipments, UEs) use location positioning systems that locate (i.e. determines the position of) devices using technologies such as Wi-Fi, Global Navigation Satellite System (GNSS) receivers and cellular communication network signals. LBS is used in 4^{th} Generation (4G) networks such as Long Term Evolution (LTE), and in 5^{th} Generation (5G) network the equivalent functionality is referred to as LoCation Services (LCS).

### SUMMARY

In Internet-of-Things (IoT) scenarios, multiple user devices may be connected, such as a laptop connected to a phone and a watch, a car, etc. Similarly the UEs of one user are also connected with UEs of another user (such as pairing phones using Bluetooth). However, these connections do not use LBS.

In 5G networks, the location information is expanded into three dimensions with better accuracy (including motion events). That is, the location information can be in the form of latitude, longitude and altitude, or a distance and a reference location’s latitude, longitude and altitude. A motion event is a location information event in 5G, where motion is determined relative to the UE location corresponding to an immediately preceding event report.

In the 5G Core (5GC) network, to facilitate cloud native implementations and deployments, a Service-Based Architecture (SBA) is used, and is based on the concept of Network Functions (NF) offering and consuming NF Services over Service Based Interfaces (SBIs)/Application Programming Interfaces (APIs). FIG. 1 depicts the 5G reference architecture as defined by the 3^{rd} Generation Partnership Project (3GPP).

FIG. 1 illustrates a 5G system reference architecture 101 showing service-based interfaces used within the Control Plane (CP). It will be appreciated that not all NFs are depicted. Service-based interfaces are represented in the format Nxyz and point to point interfaces in the format Nx. The reference architecture 101 comprises a Network Slice Selection Function (NSSF) 102 that has a Nnssf interface, a Network Exposure Function (NEF) 103 that has a Nnef interface, a Network Repository Function (NRF 604) 104 that has a Nnrf interface, a Policy Control Function (PCF) 105 that has a Npcf interface, a Unified Data Management (UDM) 106 that has a Nudm interface, an Application Function (AF) 107 that has a Naf interface, an Authentication Server Function (AUF) 108 that has a Nausf interface, an Access and Mobility Management Function (AMF) 109 that has a Namf interface, a SMF 110 that has a Nsmf interface, a Network Data Analytics Function (NWDAF) 116 that has a Nnwdaf interface, a Service Communication Proxy (SCP) 117 and a Location Management Function (LMF) 118. The AMF 109 has an N1 interface to a UE 112, and an N2 interface to an access network (AN) 113 (which can be a radio AN, RAN). The SMF 110 has an N4 interface to a User Plane Function (UPF) 114. The interface between the R(AN) 113 and the UPF 114 is the N3 interface, and the interface between the UPF 114 and a Data Network 115 is the N6 interface.

The NEF 103 supports different functionality and acts as the entry point into the operator’s network, so an external AF interacts with the 3GPP Core Network through the NEF 103. The NEF 103 supports external applications to manage a specific quality of service (QoS) of a session. The NEF 103 can be used by authorised applications to request information for a session.

The AF 107 interacts with the 3GPP Core Network, and is a representation of an application that is inside or outside the operator’s network that interacts with the 3GPP network.

The AMF 109 and the SMF 110 set up the connectivity to the UE 112 through the data network 115, and provide communications between the UE 112 and the other NFs.

The NWDAF 116 represents an operator managed network analytics logical function. The NWDAF 116 is responsible for providing network analysis information upon request from network functions. For example, a network function may request specific analysis information on the load level of a particular network slice. Alternatively, the network function can use the subscribe service to ensure that it is notified by the NWDAF 116 if the load level of a network slice changes or reaches a specific threshold.

The LMF 118 is the network entity in the 5GC supporting functionality relating to location information. In particular the LMF 118 can support location determination for a UE, obtain downlink location measurements or a location estimate from the UE, obtain uplink location measurements from the RAN, and obtain non-UE associated assistance data from the RAN.

Currently, while applications used by a particular subscriber or UE are able to make use of the location information for that subscriber or UE, it is not possible to share this information with other subscribers or UEs or for applications to make use of this information for other subscribers or UEs.

Therefore there is a desire for improvements in the sharing and use of information about subscribers and/or UEs.

As noted, currently, applications used by a particular subscriber or UE are not able to share or make use of location information for other subscribers or UEs. However, there may be benefits in being able to share this information, for example by applications being able to provide enhanced LBS to the UE. For example, with suitable information sharing and analysis, in an loT scenario, the user (UE/subscriber) practice within the same cell (such as switching to ‘flight’ mode) and/or in another cell (such as a voice assistant in the UE heard a message and carried out the user’s command on another capable device which is in the coverage of another cell) could be done through an extension of LBS. In embodiments, identifying the mobility pattern of a UE could enable the UE to be differently served with different LBS policies.

However, this additional LBS assistance can come with a cost, since LBS applications that track and share data raises privacy concerns and there is a need for user approval for these services.

Thus, retrieving and learning a user’s/UE’s practice from geographically-close and/or social network closely located UEs is missing in current LBS systems and/or applications. No existing global module or network function manages a user’s physical and/or virtual social information beyond the UE’s individual subscription. Aggregating further data enables more precise LCS that can enable a user’s habits or practices applied to one user device to be shared with other devices of the same user or different user. The user’s habits or practices could be learnt and/or predicted, so that a precise recommendation can be made, and further, can be shared with other users/UEs and affect their activities or operations.

Therefore, according to a first aspect, there is provided a method of operating a data analysis node in a communication network. The method comprises receiving, from a location information management node in the communication network, behaviour information relating to an operational state and/or configuration of a first wireless device, and a request for information identifying wireless devices that have a relationship with the first wireless device; analysing the received behaviour information for the first wireless device and behaviour information for one or more other wireless devices to identify one or more wireless devices that have a relationship with the first wireless device; and sending, to the location information management node, relationship information comprising an identity of the one or more wireless devices that are identified as having a relationship with the first wireless device.

According to a second aspect, there is provided a method of operating a mobility management node in a communication network. The method comprises receiving, from a first wireless device, behaviour information relating to an operational state and/or configuration of the first wireless device; and sending, to a location information management node in the communication network, the received behaviour information.

According to a third aspect, there is provided a method of operating a location information management node in a communication network. The method comprises receiving, from a mobility management node in the communication network, behaviour information relating to an operational state and/or configuration of the first wireless device; sending, to a data analysis node in the communication network, the received behaviour information and a request for relationship information identifying wireless devices that have a relationship with the first wireless device; and receiving, from the data analysis node, relationship information comprising an identity of the one or more wireless devices that are identified as having a relationship with the first wireless device.

According to a fourth aspect, there is provided a method of operating a node. The method comprises receiving, from a location information management node in the communication network, relationship information comprising an identity of one or more wireless devices that are identified as having a relationship with a first wireless device; and storing the received relationship information with user information for the first wireless device.

According to a fifth aspect, there is provided a method of operating a first wireless device. The method comprises sending, to a mobility management node in a communication network, behaviour information relating to an operational state and/or configuration of the first wireless device.

According to a sixth aspect, there is provided a method of operating an application function node in a communication network. The method comprises sending, to a location information management node in the communication network, a request for relationship information relating to a first wireless device; and receiving, from the location information management node, relationship information relating to the first wireless device, wherein the relationship information comprises an identity of one or more wireless devices that have a relationship with the first wireless device.

According to a seventh aspect, there is provided a method of operating a location information management node in a communication network. The method comprises receiving, from an application function node in the communication network, a request for relationship information relating to a first wireless device; retrieving the relationship information from a storage location, wherein the relationship information comprises an identity of one or more wireless devices that have a relationship with the first wireless device; and sending, to the application function node, relationship information relating to the first wireless device.

According to an eighth aspect, there is provided a method of operating a communication network. The method comprises operating a data analysis node according to the first aspect or any embodiment thereof, operating a mobility management node according to the second aspect or any embodiment thereof; and operating a location information management node according to the third aspect, the seventh aspect, or any embodiments thereof.

According to a ninth aspect, there is provided a computer program product comprising a computer readable medium having computer readable code embodied therein, the computer readable code being configured such that, on execution by a suitable computer or processor, the computer or processor is caused to perform the method of any of the first to eighth aspects.

According to a tenth aspect, there is provided a data analysis node for use in a communication network. The data analysis node is configured to receive, from a location information management node in the communication network, behaviour information relating to an operational state and/or configuration of a first wireless device, and a request for information identifying wireless devices that have a relationship with the first wireless device; analyse the received behaviour information for the first wireless device and behaviour information for one or more other wireless devices to identify one or more wireless devices that have a relationship with the first wireless device; and send, to the location information management node, relationship information comprising an identity of the one or more wireless devices that are identified as having a relationship with the first wireless device.

According to an eleventh aspect, there is provided a mobility management node for use in a communication network. The mobility management node is configured to receive, from a first wireless device, behaviour information relating to an operational state and/or configuration of the first wireless device; and send, to a location information management node in the communication network, the received behaviour information.

According to a twelfth aspect, there is provided a location information management node for use in a communication network. The location information management node is configured to receive, from a mobility management node in the communication network, behaviour information relating to an operational state and/or configuration of the first wireless device; send, to a data analysis node in the communication network, the received behaviour information and a request for relationship information identifying wireless devices that have a relationship with the first wireless device; and receive, from the data analysis node, relationship information comprising an identity of the one or more wireless devices that are identified as having a relationship with the first wireless device.

According to a thirteenth aspect, there is provided a node. The node is configured to receive, from a location information management node in the communication network, relationship information comprising an identity of one or more wireless devices that are identified as having a relationship with a first wireless device; and store the received relationship information with user information for the first wireless device.

According to a fourteenth aspect, there is provided a first wireless device. The first wireless device is configured to send, to a mobility management node in a communication network, behaviour information relating to an operational state and/or configuration of the first wireless device.

According to a fifteenth aspect, there is provided an application function node for use in or with a communication network. The application function node is configured to send, to a location information management node in the communication network, a request for relationship information relating to a first wireless device; and receive, from the location information management node, relationship information relating to the first wireless device, wherein the relationship information comprises an identity of one or more wireless devices that have a relationship with the first wireless device.

According to a sixteenth aspect, there is provided a location information management node for use in a communication network. The location information management node is configured to receive, from an application function node in the communication network, a request for relationship information relating to a first wireless device; retrieve the relationship information from a storage location, wherein the relationship information comprises an identity of one or more wireless devices that have a relationship with the first wireless device; and send, to the application function node, relationship information relating to the first wireless device.

According to a seventeenth aspect, there is provided a data analysis node for use in a communication network. The data analysis node comprises a processor and a memory. The memory contains instructions executable by said processor whereby said data analysis node is operative to receive, from a location information management node in the communication network, behaviour information relating to an operational state and/or configuration of a first wireless device, and a request for information identifying wireless devices that have a relationship with the first wireless device; analyse the received behaviour information for the first wireless device and behaviour information for one or more other wireless devices to identify one or more wireless devices that have a relationship with the first wireless device; and send, to the location information management node, relationship information comprising an identity of the one or more wireless devices that are identified as having a relationship with the first wireless device.

According to an eighteenth aspect, there is provided a mobility management node for use in a communication network. The mobility management node comprises a processor and a memory. The memory contains instructions executable by said processor whereby said mobility management node is operative to receive, from a first wireless device, behaviour information relating to an operational state and/or configuration of the first wireless device; and send, to a location information management node in the communication network, the received behaviour information.

According to a nineteenth aspect, there is provided a location information management node for use in a communication network. The location information management node comprises a processor and a memory. The memory contains instructions executable by said processor whereby said location information management node is operative to: receive, from a mobility management node in the communication network, behaviour information relating to an operational state and/or configuration of the first wireless device; send, to a data analysis node in the communication network, the received behaviour information and a request for relationship information identifying wireless devices that have a relationship with the first wireless device; and receive, from the data analysis node, relationship information comprising an identity of the one or more wireless devices that are identified as having a relationship with the first wireless device.

According to a twentieth aspect, there is provided a node. The node comprises a processor and a memory. The memory contains instructions executable by said processor whereby said node is operative to receive, from a location information management node in the communication network, relationship information comprising an identity of one or more wireless devices that are identified as having a relationship with a first wireless device; and store the received relationship information with user information for the first wireless device.

According to a twenty-first aspect, there is provided a first wireless device. The first wireless device comprises a processor and a memory. The memory contains instructions executable by said processor whereby said first wireless device is operative to send, to a mobility management node in a communication network, behaviour information relating to an operational state and/or configuration of the first wireless device.

According to a twenty-second aspect, there is provided an application function node for use in or with a communication network. The application function node comprises a processor and a memory. The memory contains instructions executable by said processor whereby said application function node is operative to send, to a location information management node in the communication network, a request for relationship information relating to a first wireless device; and receive, from the location information management node, relationship information relating to the first wireless device, wherein the relationship information comprises an identity of one or more wireless devices that have a relationship with the first wireless device.

According to a twenty-third aspect, there is provided a location information management node for use in a communication network. The location information management node comprises a processor and a memory. The memory contains instructions executable by said processor whereby said location information management node is operative to receive, from an application function node in the communication network, a request for relationship information relating to a first wireless device; retrieve the relationship information from a storage location, wherein the relationship information comprises an identity of one or more wireless devices that have a relationship with the first wireless device; and send, to the application function node, relationship information relating to the first wireless device.

### BRIEF DESCRIPTION OF THE DRAWINGS

Various embodiments are described herein with reference to the following drawings, in which:

FIG. 1 is a diagram illustrating a 5G system reference architecture;

FIG. 2 is a signalling diagram illustrating exemplary signalling between nodes to establish relationship information for a UE;

FIG. 3 is an illustration of an exemplary collaborative graph that can be determined according to the techniques described herein;

FIG. 4 is a signalling diagram illustrating an exemplary process enabling an application function to use relationship information for a UE;

FIG. 5 is a block diagram illustrating a User Equipment in accordance with some embodiments;

FIG. 6 is a block diagram illustrating a virtualisation environment in accordance with some embodiments;

FIG. 7 is a block diagram of a data analysis node according to various embodiments;

FIG. 8 is a block diagram of a mobility management node according to various embodiments;

FIG. 9 is a block diagram of a location information management node according to various embodiments;

FIG. 10 is a block diagram of a subscriber information storage node according to various embodiments;

FIG. 11 is a block diagram of a wireless device according to various embodiments;

FIG. 12 is a block diagram of an application function according to various embodiments;

FIG. 13 is a flow chart illustrating a method of operating a data analysis node according to various embodiments;

FIG. 14 is a flow chart illustrating a method of operating a mobility management node according to various embodiments;

FIG. 15 is a flow chart illustrating a method of operating a location information management node according to various embodiments;

FIG. 16 is a flow chart illustrating a method of operating a subscriber information storage node according to various embodiments;

FIG. 17 is a flow chart illustrating a method of operating a wireless device according to various embodiments;

FIG. 18 is a flow chart illustrating a method of operating an application function according to various embodiments; and

FIG. 19 is a flow chart illustrating a method of operating a location information management node according to various further embodiments.

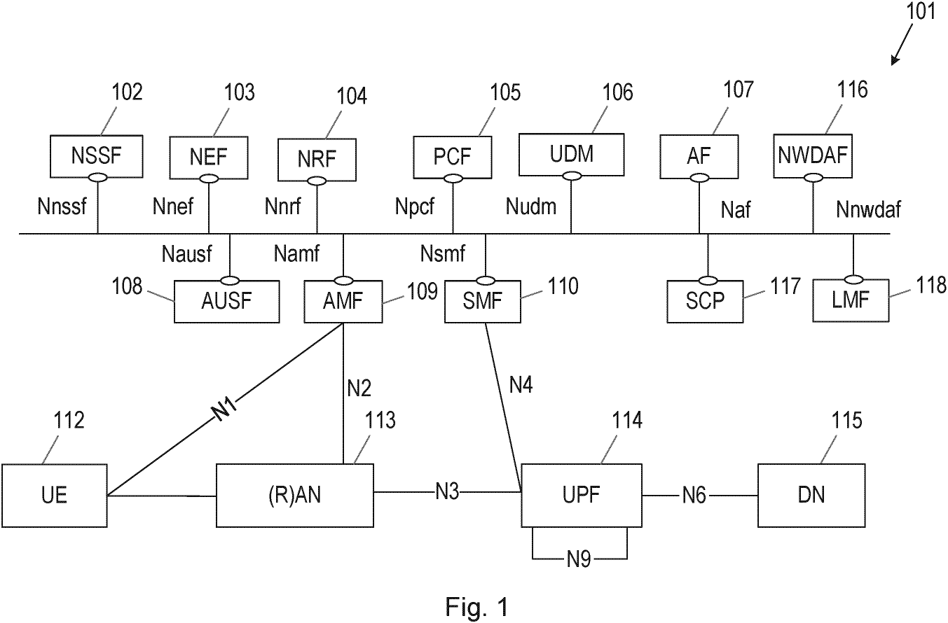

### DETAILED DESCRIPTION OF THE PREFERRED EMBODIMENTS

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing units, one or more processing modules or one or more controllers, and the terms computer, processor, processing unit, processing module and controller may be employed interchangeably. When provided by a computer, processor, processing unit, processing module or controller, the functions may be provided by a single dedicated computer, processor, processing unit, processing module or controller, by a single shared computer, processor, processing unit, processing module or controller, or by a plurality of individual computers, processors, processing units, processing modules or controllers, some of which may be shared or distributed. Moreover, these terms also refer to other hardware capable of performing such functions and/or executing software, such as the example hardware recited above.

Although in the description below the term user equipment (UE) is used, it should be understood by the skilled in the art that “UE” is a non-limiting term comprising any mobile or wireless device or node equipped with a radio interface allowing for at least one of: transmitting signals in uplink (UL) and receiving and/or measuring signals in downlink (DL). A UE herein may comprise a UE (in its general sense) capable of operating or at least performing measurements in one or more frequencies, carrier frequencies, component carriers or frequency bands. It may be a “UE” operating in single- or multi-radio access technology (RAT) or multi-standard mode. As well as “UE” and “wireless device”, the term “mobile device” may be used, and it will be appreciated that such a device does not necessarily have to be ‘mobile’ in the sense that it is carried by a user. Instead, the terms “mobile device”, “wireless device” and “UE” encompass any device that is capable of communicating with communication networks that operate according to one or more mobile communication standards, such as the Global System for Mobile communications, GSM, Universal Mobile Telecommunications System (UMTS), Wideband Code-Division Multiple Access (WCDMA), Long-Term Evolution (LTE), New Radio (NR), etc.

A cell is associated with a base station, where a base station comprises in a general sense any network node transmitting radio signals in the downlink and/or receiving radio signals in the uplink. Some example base stations, or terms used for describing base stations, are eNodeB, eNB, NodeB, gNB, Wireless Local Area Network (WLAN) Access Point (AP), macro/micro/pico/femto radio base station, home eNodeB (also known as femto base station), relay, repeater, sensor, transmitting-only radio nodes or receiving-only radio nodes. A base station may operate or at least perform measurements in one or more frequencies, carrier frequencies or frequency bands and may be capable of carrier aggregation. It may also be a single-radio access technology (RAT), multi-RAT, or multi-standard node, e.g., using the same or different base band modules for different RATs.

As set out above, the techniques described herein enable applications used by a particular subscriber or UE to provide enhanced location-based services (LBS) to the UE by making use of information about other subscribers or UEs. Aggregating data enables more precise LCS that can enable a user’s habits or practices applied to one user device to be shared with other devices of the same user or different user. The user’s habits or practices could be learnt and/or predicted, so that a precise recommendation can be made, and further, can be shared with other users/UEs and affect their activities or operations.

The techniques described herein can be used to adapt current LBS and LCS and combine them with a user’s practice on IoT devices connected through a particular communication medium (e.g. Bluetooth pairing, etc.) and/or a user’s connections with other users, such as social media connections. The relationships with other users can be identified from user traffic information (e.g. data traffic from similar call flows, through deep packet inspection (DPI) or other methods) to perform community detection and produce social network modelling. More generally, behaviour information relating to the operational state and/or configuration of a user’s wireless device can be analysed along with similar information for other users and/or other wireless devices to determine relationships between the users and/or wireless devices.

In embodiments the techniques herein expand the conventional LCS targeting a UE to connect to other UEs (which are referred to herein as “collaborating UEs”). This collaboration connection or relationship can have different levels, types or ‘ranks’ (for example own devices, devices of another user, etc.). Different LCS policies, data mining technologies and a learning system or rules can be applied based on the ranking (type) of the connection. For example a different policy can be applied to a UE of another user compared to a policy applied to another UE personally owned by the same user).

The techniques herein can also expose service discovery and a user’s social network modelling as an addition for current LCS messaging, for a Network Exposure Function (NEF) to expose it for further mining services (e.g. a recommendation system).

Embodiments of the techniques herein can also be used to extend the 5G Core and SBA functions to add social network alignment capability to an NWDAF, and/or add a new signalling event in a LCS service loop in the RAN.

These techniques and/or embodiments can provide one or more of the following advantages. In LBS or LCS, a user persona/practice could be further enriched through mining with relative mobility information, beyond the current absolute location information retrieved from General Packet Radio Service (GPRS), cell-id and Time Difference Of Arrival (TDOA), etc. Service discovery based on UE-to-UE communication can be improved by UEs sharing some services between each other.

One potential use case of the techniques described herein is a LBS emergency service that identifies a potential user that also requires the user’s practice. For example, there exists a current need in a population dense area of identifying the contacts of an infected person. A pre-allocation of radio resources and handover alerts should be delivered to these UEs, especially at times when the network is busy as packet congestion occurs. Public transport could be alerted when approaching a heavily affected area, and for autonomous vehicles, be guided to avoid these areas through Artificial Intelligence (Al)/policy-based event triggers and handover practice.

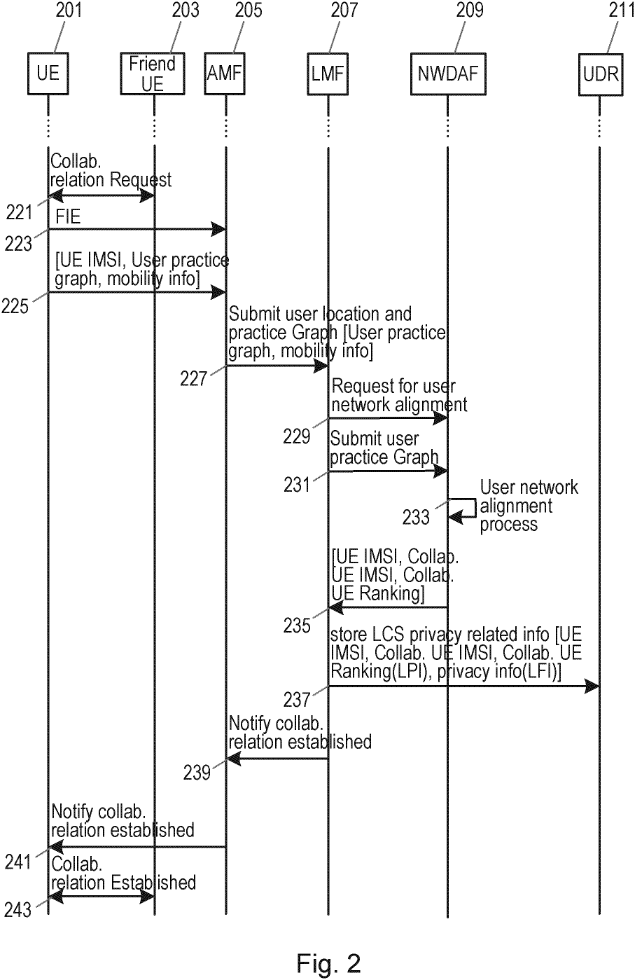

FIG. 2 is a signalling diagram illustrating exemplary signalling between nodes to establish relationship information for a UE. The signalling procedure in FIG. 2 is also referred to as an initialisation phase. The nodes in FIG. 2 include the UE 201 that the relationship information is being established for (also referred to herein as the ‘first wireless device’ and ‘first UE’), a ‘Friend UE’ 203 that the first UE 201 may collaborate with in some way (the Friend UE 203 also referred to as a ‘collaborating UE’), an AMF 205, a LMF 207, an NWDAF 209 and a UDR 211. The Friend UE 203 can be another UE/wireless device, including a device that is part of the IoT or a constrained device, or it can be another device that the first UE 201 can connect and/or exchange data/information with. It will be appreciated that the first UE 201 can interact or collaborate with multiple different ‘Friend UEs’, but for ease of illustration, only a single Friend UE 203 is shown in FIG. 2.

Briefly, in the initialisation phase shown in FIG. 2, for a first UE 201 information about collaborating UEs, along with their respective user practice information and/or graphs can be transferred to and stored in the core network (e.g. in the 5GC) and one or more collaborative relationships can be established among the UEs.

Firstly, for relationship information to be identified between the first UE 201 and other UEs 203, some form of relationship needs to exist. This is represented in FIG. 2 by a Collaboration Relation Request 221 signal sent between the first UE 201 and the Friend UE 203. This Collaboration Relation Request 221 can be a request for any form of collaboration between the UEs 201, 203. For example, the request can be a pairing request, e.g. via Bluetooth, WiFi, a connection request (including to a previously-paired device), such as sharing a screen, sending a message, video file, audio file, etc. More generally, the request can be for a short-range direct wireless connection between the UEs 201, 203, such as via Bluetooth, WiFi Direct, or LTE/NR Direct; or the request can be for an indirect wireless connection between the UEs 201, 203 via a third node, such as in a 3GPP 4G or 5G network through the same eNB or gNB, or in a IEEE 802.11 WiFi network via the same Access Point (AP). It will be appreciated that the Collaboration Relation Request 221 itself does not form part of the initialisation procedure.

If the Collaboration Relation Request 221 results in a successful execution (e.g. a Bluetooth connection is established, data is shared, etc.), this event can be communicated by the first UE 201 to the core network so that the information can be used as part of establishing relationships for the first UE 201. The communication of this event is indicated by signal 223. Signal 223 is sent by the first UE 201 to the AMF 205. In some embodiments, this event can be referred to as a ‘Friend Interaction Event’ (FIE). This event can announce a potential collaboration connection to the network.

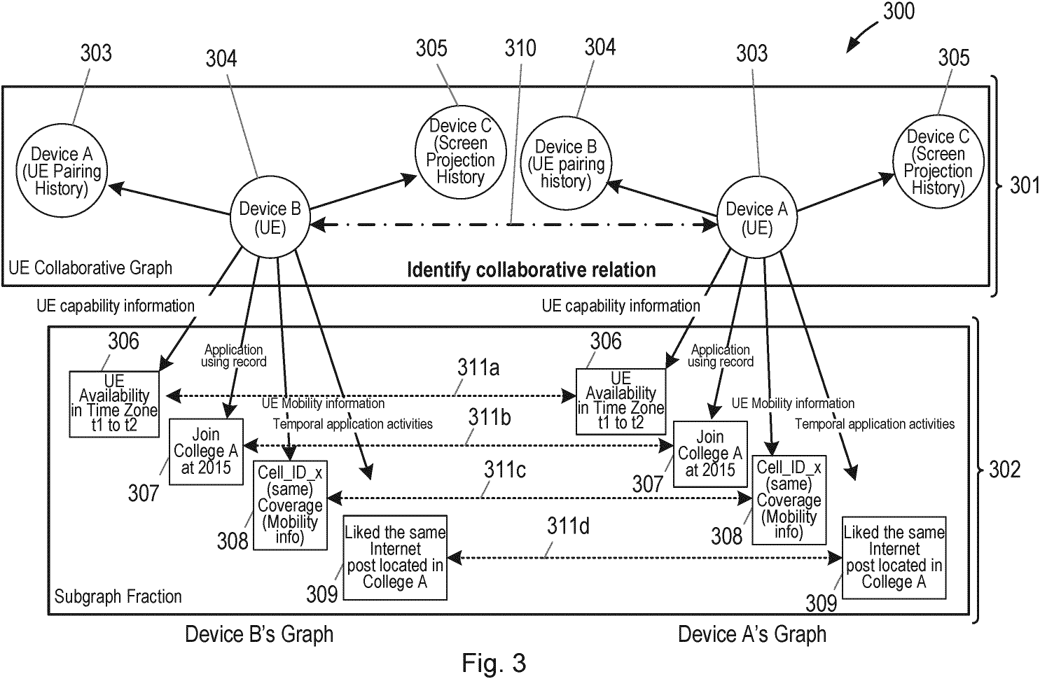

To further enable the network to determine the relationships for the first UE 201, the first UE 201 sends behaviour information relating to operational state or configuration of the first UE 201 to the network. This is shown by signal 225. Signal 225 may be Radio Resource Control (RRC) signalling. The behaviour information can include any of: mobility information for the first UE 201; Location Service information such as any of UE availability, UE Location Area, UE Periodic Location and UE motion; configuration information such as any of UE configuration (e.g. state, mode, etc.), UE capability(ies) (e.g. battery, radio capability, computational capability, etc.) and interaction information; and UE data session-related information, such as a QoS/5G QoS indicator (5QI) information. The interaction information relates to interactions between the first UE 201 and one or more other UEs 203 or devices. In some embodiments the behaviour information can include or be in the form of a user practice graph, which is described further below with reference to FIG. 3. The information sent in signal 225 can also include an identifier for the first UE 201, such as an International Mobile Equipment Identity (IMEI), and/or an identifier for the subscriber associated with the first UE 201, such as an International Mobile Subscriber Identity (IMSI).

The AMF 205 receives the behaviour information from the first UE 201 and forwards the information to the LMF 207, as shown by signal 227. The AMF 205 may also provide location information for the first UE 201 in signal 227.

The LMF 207 receives the behaviour information for the first UE 201 from the AMF 205. The LMF 207 sends a request 229 to the NWDAF 209 for the NWDAF 209 to identify one or more relationships for the first UE 201. The LMF 207 also forwards the received behaviour information (e.g. the user practice graph) to the NWDAF 209, as shown by signal 231.

In some embodiments (although not shown in FIG. 2), the NWDAF 209 may have requested the AMF 205 to retrieve the behaviour information from the first UE 201.

In step 233 the NWDAF 209 analyses the received behaviour information and similar types of behaviour information that has previously been received for other UEs or other devices to identify one or more relationships between the first UE 201 and one or more other UEs and/or devices. This step is also referred to as a ‘user network alignment process’. Relationships may be identified where there are similarities between the behaviour information of the first UE 201 and behaviour information for other UEs. In some embodiments, the NWDAF 209 may also obtain information about the first UE’s subscription to the communication network by obtaining subscription information from the UDR 211 (a request for this information is not shown in FIG. 2), and analyse the obtained subscription information along with the received behaviour information to determine the existence of any relationships with other UEs/devices or users.

Once the NWDAF 209 has identified a relationship for the first UE 201, the NWDAF 209 can send relationship information to the LMF 207. This is shown as signal 235. The relationship information can include an identity of one or more UEs and/or devices that have been identified as having a relationship with the first UE 201. In some embodiments, the relationship information can include an identity of these one or more UEs and/or devices, such as an IMSI and/or IMEI, a Medium Access Control (MAC) address, an Internet Protocol (IP) address, etc. In some embodiments, the relationship information can also indicate a type of relationship that is applicable to these one or more UEs and/or devices. The ‘type of relationship’ is also referred to herein as a ‘ranking’ or ‘rank’. The relationship information is also referred to herein as Collaboration Connection Information (CCI).

The LMF 207 can store the relationship information in UDR 211 by sending the information to the UDR 211 (shown by signal 237). The information sent in signal 237 may also include LCS-related information, including LCS privacy related information, such as a LCS privacy indicator (LPI). In particular, since inferencing potential ‘collaborating’ devices and their ranking (relationship type) across the network requires information from a user practice record (also referred to herein as a user practice graph) and network key performance indicators (KPIs). Many of these are sensitive and private information. A new KPI is proposed that can record a UE’s ‘collaborative ranking’ in the UDR. This new KPI is referred to as a Location Friend indicator (LFI), and in some embodiments the LFI can be in the form of a number that represents a particular rank. This KPI can be continuously updated, by an AMF that is serving the UE, via a UDM node. This KPI can be managed alongside a UE’s privacy information including a LPI, etc.

In some embodiments, the relationship information may be also or alternatively stored in the first UE 201. In this case, the relationship information can be also or alternatively sent by the LMF 207 to the first UE 201. This is not shown in FIG. 2.

The LMF 207 can inform the AMF 205 that a relationship has been identified or established, and this is shown by signal 239. The AMF 205 can then inform the first UE 201 that a relationship has been identified or established, via signal 241.

Assuming that the Friend UE 203 is a UE identified as being in a relationship with the first UE 201, a collaboration relationship is established between the first UE 201 and the Friend UE 203, as shown by signal 243.

Some further details of step 233 (the analysis by the NWDAF 209 to identify relationships) are now provided.

The NWDAF 209 can establish relationships from the pairing up or connections with other UEs/devices. These connections can be divided into different types of relationship, such as all of the first UE’s own devices (e.g. smartphone, tablet, laptop, display screen, smartwatch, car, etc.) could be a first rank/type. A pairing with a device owned by another person (for example someone that the owner of the first UE may go for runs with and they keep each other informed about each other’s locations by connecting the smartwatches of both people) could be of another rank.

Some exemplary ranks or types of relationships can include, but are not limited to, Rank 1: Personal devices; Rank 2: Geographically-based ‘Collaborating’ devices (this can include devices of other users also); Rank 3: application-based social networked devices, etc.

The relationships can be established in native, automated or user-triggered manners. In an automated collaboration connection (relationship) establishment, the first UE 201 can be paired up with other UEs/devices in an automated way, for example based on network key performance indicators (KPIs) and/or subscription management information. For example a relationship can be identified based on a connection between devices being established through a Bluetooth handshake connection, or through a Constrained Application Protocol (CoAP) connection in the case of an IoT device. As another example, a relationship can be identified by clustering UEs that frequently connect to same access point (AP), e.g. in the case of WIFI. As another example, a relationship can be identified based on UEs that use similar network slicing instance or cell. As another example, a relationship can be identified based on similar device related KPI(s), for example radio capability, battery status, etc., which can be shared through a Radio Resource Control (RRC) channel with the first UE 201. As another example, a relationship can be identified based on application-level user behaviour. It will be appreciated that relationships can be identified based on a combination of any of the above.

One implementation of automated collaboration connection establishment by the NWDAF 209 can be based on a graph-based Machine Learning (ML) algorithm. In this approach, a UE’s/subscriber’s mobility information, behaviour and figuring could be modelled as a graph, and compared to corresponding graphs for other devices.

FIG. 3 is an illustration of an exemplary collaborative graph 300 that can be determined according to the techniques described herein. The graph 300 can be used to establish a relationship according to the third type/rank above, i.e. application-based social networked devices. The exemplary graph 300 comprises two layers, a UE collaborative graph layer 301 that indicates connections with other UEs/devices, and a UE subgraph layer 302 that indicates aspects of the relevant UE’s behaviour information. Each layer includes information for several devices/UEs and indicates how the devices/UEs may be related or interact. In the right hand side of the UE collaborative graph layer 301, behaviour information for a Device A 303 is shown (this can be considered to be the first UE 201 from FIG. 2). The behaviour information for Device A 303 indicates that it has frequently paired with a Device B 304 (e.g. another UE) via Bluetooth in the last month, and also projected its screen to a Device C 305 (e.g. a display screen) more frequently than any other projection device/via Bluetooth all of the time. The left hand side of the UE collaborative graph layer 301 shows behaviour information for Device B 304, which indicates that Device B 304 has frequently paired with a Device A 303 via Bluetooth in the last month, and also projected its screen to Device C 305 (e.g. a display screen) more frequently than any other projection device/via Bluetooth all of the time.

The right hand side of the UE subgraph layer 302 indicates aspects of the behaviour information for Device A 303. In particular the behaviour information for Device A 303 includes information 306 relating to Device A’s availability in a particular time zone(s), information 307 obtained from a social media network timeline (e.g. Device A joined a College A in 2015), a Cell identifier(s) 308 of cells in a communication network Device A 303 has been using (e.g. Cell_ID_x) and information 309 on postings to and/or other interactions with social media applications (such as ‘likes’). Information 306 and the cell identifier(s) 308 can be obtained from mobility information for Device A 303. Information 307 can be obtained from the relevant software application or from access to the web-based social media profile of the user of Device A 303. Information 309 can be obtained by analysis of temporal software application activities. Corresponding information for Device B 304 is shown in the left hand side of the UE subgraph layer 302.

Analysis of the information in the collaborative graph 300 by the NWDAF can result in the NWDAF identifying a relationship between Device A 303 and Device B 304 in view of the similarities (and overlap) in the connections shown in the UE collaborative graph layer 301 for Device A 303 and Device B 304, and the common/overlapping behaviour shown in the UE subgraph layer 302. This relationship between Device A 303 and Device B 304 is indicated by the dashed arrow 310. Dashed arrows 311a-311d indicate similarities between the information types in the UE subgraph layer 302.

In the UE collaborative graph layer 301, the vertices are other UEs or devices where some previous interaction has been recorded, and edges are a pre-defined ‘confidence index’ for different interaction method towards building a collaboration relation as indicated by dashed line 310.

In the UE subgraph layer 302, vertices are the UE’s entity (elements of the collaboration information of the UE) required to identify a potential collaboration connection. Edges are a predefined ‘contribution index’, to describe how having such an entity contributes to the likelihood of the UE having a collaboration relation with other vertices (UE) with the same entity.

As noted above, the right and left hand sides of the collaborative graph 300 represent exemplary behaviour information for Device A 303 and Device B 304 respectively. This form of representing the behaviour information is also referred to as a user practice graph.

With such a graphical representation of the behaviour information, identifying the potential collaboration relations can be regarded as a social network alignment problem. One way in which the NWDAF can solve this problem is by encoding the graph into vector and performing similarity check. A known technique for solving this type of graphical encoding task is a graph convolution network (GCN) on graph embedding, with one optional implementation being described in “Cross-lingual knowledge graph alignment via graph matching neural network” by Xu, Kun, et al., arXiv preprint arXiv: 1905.11605 (2019).

For a Graph G_{A} for Device A 303 and a Graph G_{B} for Device B 304, an exemplary 4-layered GCN can be used to measure the similarity between the two graphs as follows. In an Input Representation layer the NWDAF can learn the embedding of each entity though a Grap2Seq encoder (e.g. as described in “Graph2seq: Graph to sequence learning with attention-based neural networks” by Xu, Kun, et al., arXiv preprint arXiv: 1804.00823 (2018)) using the ‘confidence index’ and ‘contribution index’ as link weights. In a Node Matching layer, each entity embedding of Device A 303 is compared to all the entities embedding other devices, and the similarity can be described as a function (e.g. a cosine function) between the two embedding vectors. The most similar entities are matched (e.g. as illustrated by the dashed lines 311a-d in FIG. 3). In a Graph-level matching layer, the similarity between the paired entities determined in the Node Matching layer is used as the input to a feed forward neural network, and an output layer with a so-called ‘SoftMax’ function is used to describe the similarity between the two graphs. If the similarity is above a predefined threshold, then a Rank 3 collaboration/relationship can be established.

It will be appreciated that other ML-based approaches are possible. Beyond ML-based approaches, similar automation of the relationship establishment can be reached through decision tree techniques, label propagation algorithms (LPAs), etc. The input and output parameters for these approaches will be similar. In general, the behaviour information for Device A 303 and the behaviour information for Device B 304 (and the behaviour information for any other devices) can be provided as inputs to the ML algorithm. The ML algorithm analyses the input behaviour information to determine measures of similarity between the behaviour information for Device A 303 and the behaviour information for the other devices. Relationships with other devices are identified as those devices for which the respective behaviour information has a required measure of similarity with the behaviour information for Device A 303. The required measure of similarity may be any measure of similarity that is above a threshold value, the highest measure of similarity, the N highest measures of similarity (where N is some defined number), or a combination thereof.

As an alternative to the automated relationship establishment, it is possible for the relationship establishment to be user triggered. In this case, a user of a device (e.g. Device A 303) can set, manipulate and manage the devices that they have a relationship with at an application/device configuration level. A time limit may be associated with a relationship (e.g. the relationship is only valid for a certain amount of time in the absence of other relevant interactions with Device A 303), and if so, the user can increase or decrease the lifetime of a collaboration connection at an application/device configuration level.

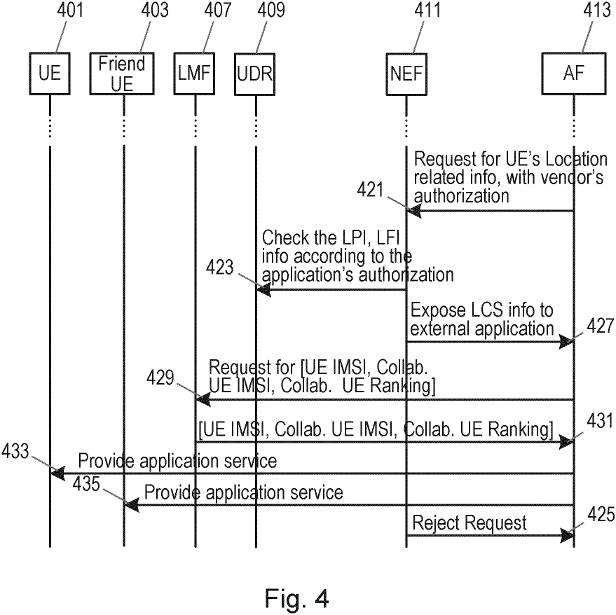

FIG. 4 is a signalling diagram illustrating an exemplary process enabling an application function to use relationship information that has been determined for a UE. The signalling procedure in FIG. 4 is also referred to as a utilisation phase. The nodes in FIG. 4 include the first UE 401 that the relationship information has been established for according to the method in FIG. 2, ‘Friend UE’ 403 that the first UE 401 is established to be in a relationship with, an AMF 405, a LMF 407, a UDR 409, a NEF 411 and a AF 413. In some embodiments the AF 413 may be an Application Server. It will be appreciated that the first UE 201 may have an established relationship with multiple different ‘Friend UEs’, but for ease of illustration, only a single Friend UE 403 is shown in FIG. 4.

As noted above with reference to FIG. 2, the collaboration connection information (CCI) may have been stored using a distributed approach in the first UE 401, and/or stored in UDR 409. In the process shown in FIG. 4, the relationship information (CCI) is provided to an Application Server on request during an application runtime.

In a first step, the AF 413 requests relationship information for the first UE 401 by sending a request 421 to the NEF 411. This request 421 can be a request for the first UE’s location related information. As known in the art, different AFs 413 (e.g. different Application Servers) may have different authorisation levels to control access to different NFs and/or information provided by the 5G core. Thus the AF 413 may have sent the request 421 subject to authorisation to access the first UE’s location related information by a vendor.

In view of the 5GC capability for the NEF 411 to expose the LMF 407 and UDR 409 to the Internet and for there to be different authorisation levels for the AF 413, the AF 413 can request access to the “Collaboration information”, and the NEF 411 can determine whether access is permitted by querying the LFI in UDR.

The NEF 411 queries the UDR 409 with signal 423 to check the LCS privacy indicator (LPI) and Location Friend Indicator (LFI) stored in the UDR 409 for the first UE 401. Based on the LPI and the LFI for the first UE 401, the NEF 411 determines whether to grant access to the relationship information for the first UE 401 to the AF 413. In some embodiments, based on the LPI and/or the LFI for the first UE 401, the NEF 411 determines the extent to which access to the relationship information for the first UE 401 is granted to the AF 413. In embodiments where rankings are related to the privacy level or sensitivity of the location information, the LPI and/or the LFI for the first UE 401 can be used to determine the level of access to the relationship information for the first UE 401 that the AF 413 can be granted access to. In one example, based on the exemplary Ranks 1-3 described above, the NEF 411 can determine that only the Rank 1 relationship information can be accessed by the AF 413 if the LPI and/or the LFI indicate that relationship information for the first UE 401 is accessible, but not the first UE’s mobility information. However the NEF 411 can determine that the Rank 1 and Rank 2 relationship information can be accessed by the AF 413 if the LPI and/or the LFI indicate that relationship information for the first UE 401 is accessible, including the first UE’s mobility information, but not the first UE’s user practice/application usage data. However, if the LPI and/or the LFI indicate that all ranks of the relationship information for the first UE 401 are accessible (i.e. including the first UE’s mobility information, and the first UE’s user practice/application usage data), then the NEF 411 can determine that the Rank 1, 2 and 3 relationship information can be access by the AF 413.

If access is denied, the NEF 411 sends a rejection message 425 to the AF 413, and this terminates the process.

However, if access is granted to the AF 413, the NEF 411 exposes the LMF 407 and the UDR 409 (and in particular the LCS information, including the relationship information) to the AF 413. This is indicated to the AF 413 by the NEF 411 via signal 427.

The AF 413 then sends a request 427 to the LMF 407 for the relationship information for the first UE 401. This request 427 can include an identifier for the first UE 401, for example the first UE’s IMSI. In some embodiments, the request 427 from the AF 413 requests information including any of the first UE’s identifier (e.g. IMSI), an identifier (e.g. IMSI) for any collaborating UE 403, and a collaboration relation ranking (i.e. relationship type).

The LMF 407 responds to the AF 413 with the requested information, as indicated by signal 431.

Based on the received information, including the ranking, the AF 413 can provide an improved personalised service to the first UE 401 (indicated by signal 433), and optionally also provide an improved personalised service to the Friend UE 403 (indicated by signal 435). Signal 433 and signal 435 can be existing LCS signalling.

In 3GPP TS 23.273 Release 16 there are currently four events catering for LBS. These include: UE availability, Area, periodic Location and motion. On the one hand, these provide a detailed user mobility description, but this does not cover IoT devices, which have a lot of interactions with/through IoT facilities, including connected vehicles, autonomous drones, etc. According to the techniques described herein these types of events can be defined as a ‘Friend interaction Event’ (FIE). Based on different rankings of collaborative relationships in LFI, Friend interaction Events are in the same ranking methodology, and can have different levels of authorisation to access the UE information. LCS can be provided for an established ‘collaboration connection’, through the above-mentioned triggering events. Some optional and exemplary use cases are set out below:

In a first example, when a user with their UE arrives at an airport, its ‘flight mode’ will be automatically switched on when all the collaborative UEs are also switched to ‘flight mode’. In this case, the collaboration relation between the UE and the other UEs can be automatically established by a NWDAF due to the UEs all connecting to the same airport Wi-Fi access point and being in a close geographical location). Subsequently, flight mode can be deactivated according to a similar crowd-sourcing approach when the user lands at the destination.

In a second example, when a user and a UE (whose configuration information and mobility information is shared) lands at an airport and leaves a drone-restricted area, the UE’s ‘flight mode’ can be automatically deactivated, with this being triggered by a delivery company’s logistic drone at the airport through a FIE in LCS, and the delivery company’s mobile application installed on the UE. Here, the collaborative UE (the logistic drone) can be identified based on a user trigger established through application information, with the action towards the UE being carried out by the communication network.

In a third example, when a user of UE that has an infectious disease or condition enters or boards a connected vehicle (also a UE), the user’s UE can trigger a FIE to the connected vehicle (which could be a taxi, bus, coach, train, ferry, aeroplane, etc.) and all the passengers currently in or on board the vehicle can be recorded or noted by the connected vehicle for subsequent medical observation. In this case the collaborative relationship can be established by a native relationship between a handheld UE to loT infrastructure.

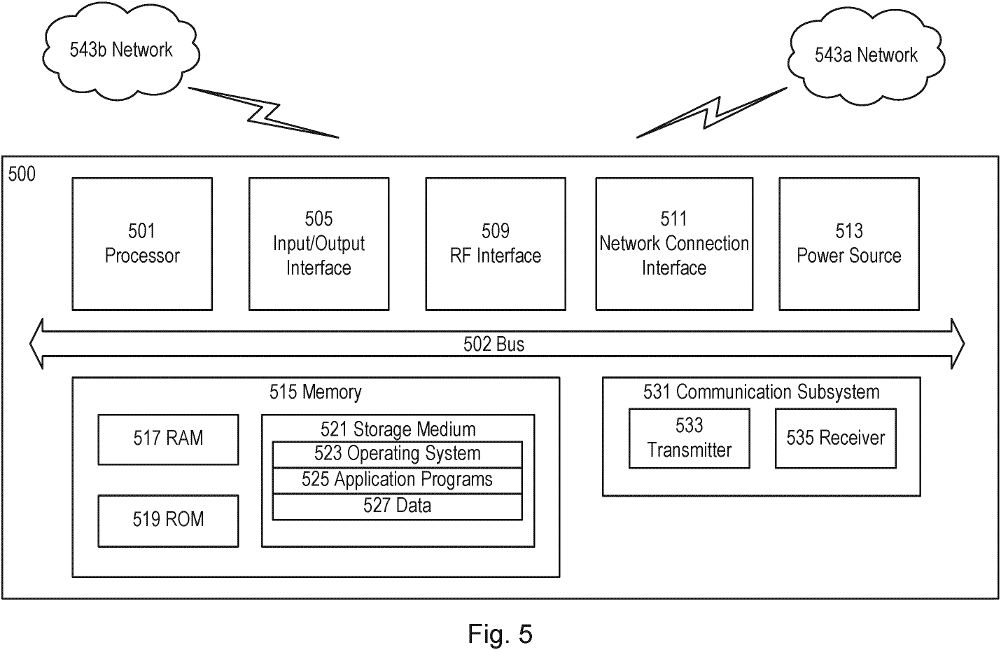

FIG. 5 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 500 may be any UE identified by the 3rd Generation Partnership Project (3GPP), including a NB-IoT UE, a machine type communication (MTC) UE, and/or an enhanced MTC (eMTC) UE. UE 500, as illustrated in FIG. 5, is one example of a WD configured for communication in accordance with one or more communication standards promulgated by the 3rd Generation Partnership Project (3GPP), such as 3GPP’s GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 500 includes processing circuitry 501 that is operatively coupled to input/output interface 505, radio frequency (RF) interface 509, network connection interface 511, memory 515 including random access memory (RAM) 517, read-only memory (ROM) 519, and storage medium 521 or the like, communication subsystem 531, power source 533, and/or any other component, or any combination thereof. Storage medium 521 includes operating system 523, application program 525, and data 527. In other embodiments, storage medium 521 may include other similar types of information. Certain UEs may utilize all of the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In the depicted embodiment, input/output interface 505 may be configured to provide a communication interface to an input device, output device, or input and output device. UE 500 may be configured to use an output device via input/output interface 505. An output device may use the same type of interface port as an input device. For example, a USB port may be used to provide input to and output from UE 500. The output device may be a speaker, a sound card, a video card, a display, a monitor, a printer, an actuator, an emitter, a smartcard, another output device, or any combination thereof. UE 500 may be configured to use an input device via input/output interface 505 to allow a user to capture information into UE 500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 509 may be configured to provide a communication interface to RF components such as a transmitter, a receiver, and an antenna. Network connection interface 511 may be configured to provide a communication interface to network 543a. Network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. Network connection interface 511 may be configured to include a receiver and a transmitter interface used to communicate with one or more other devices over a communication network according to one or more communication protocols, such as Ethernet, TCP/IP, SONET, ATM, or the like. Network connection interface 511 may implement receiver and transmitter functionality appropriate to the communication network links (e.g., optical, electrical, and the like). The transmitter and receiver functions may share circuit components, software or firmware, or alternatively may be implemented separately.

RAM 517 may be configured to interface via bus 502 to processing circuitry 501 to provide storage or caching of data or computer instructions during the execution of software programs such as the operating system, application programs, and device drivers. ROM 519 may be configured to provide computer instructions or data to processing circuitry 501. For example, ROM 519 may be configured to store invariant low-level system code or data for basic system functions such as basic input and output (I/O), startup, or reception of keystrokes from a keyboard that are stored in a non-volatile memory. Storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 521 may be configured to include operating system 523, application program 525 such as a web browser application, a widget or gadget engine or another application, and data file 527. Storage medium 521 may store, for use by UE 500, any of a variety of various operating systems or combinations of operating systems.

Storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 521 may allow UE 500 to access computer-executable instructions, application programs or the like, stored on transitory or non-transitory memory media, to off-load data, or to upload data. An article of manufacture, such as one utilizing a communication system may be tangibly embodied in storage medium 521, which may comprise a device readable medium.

In FIG. 5, processing circuitry 501 may be configured to communicate with network 543b using communication subsystem 531. Network 543a and network 543b may be the same network or networks or different network or networks. Communication subsystem 531 may be configured to include one or more transceivers used to communicate with network 543b. For example, communication subsystem 531 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software or firmware, or alternatively may be implemented separately.

In the illustrated embodiment, the communication functions of communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 531 may include cellular communication, Wi-Fi communication, Bluetooth communication, and GPS communication. Network 543b may encompass wired and/or wireless networks such as a local-area network (LAN), a wide-area network (WAN), a computer network, a wireless network, a telecommunications network, another like network or any combination thereof. For example, network 543b may be a cellular network, a Wi-Fi network, and/or a near-field network. Power source 513 may be configured to provide alternating current (AC) or direct current (DC) power to components of UE 500.

The features, benefits and/or functions described herein may be implemented in one of the components of UE 500 or partitioned across multiple components of UE 500. Further, the features, benefits, and/or functions described herein may be implemented in any combination of hardware, software or firmware. In one example, communication subsystem 531 may be configured to include any of the components described herein. Further, processing circuitry 501 may be configured to communicate with any of such components over bus 502. In another example, any of such components may be represented by program instructions stored in memory that when executed by processing circuitry 501 perform the corresponding functions described herein. In another example, the functionality of any of such components may be partitioned between processing circuitry 501 and communication subsystem 531. In another example, the non-computationally intensive functions of any of such components may be implemented in software or firmware and the computationally intensive functions may be implemented in hardware.

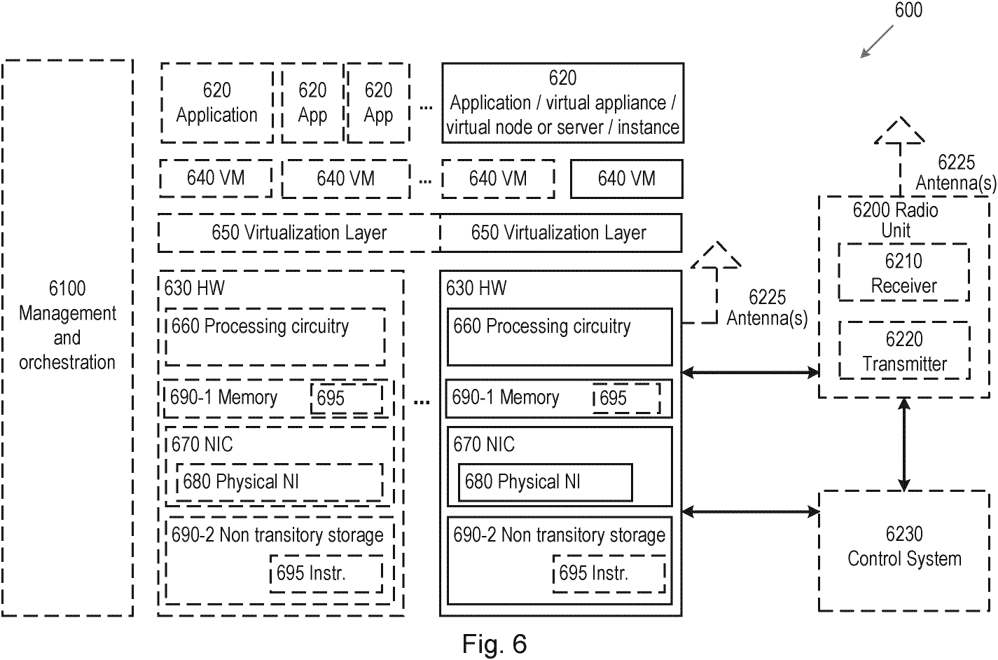

FIG. 6 is a schematic block diagram illustrating a virtualization environment 600 in which functions implemented by some embodiments may be virtualized. In the present context, virtualizing means creating virtual versions of apparatuses or devices which may include virtualizing hardware platforms, storage devices and networking resources. As used herein, virtualization can be applied to a node or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks). In particular embodiments, the virtualization environment 600 can be used to implement any one or more (or all) of the nodes described herein, such as a data analysis node (e.g. an NWDAF), a mobility management node (e.g. an AMF), a location information management node (e.g. a LMF), a subscriber information storage node (e.g. a UDR), a wireless device and an application function (e.g. an AF).

In some embodiments, some or all of the functions described herein may be implemented as virtual components executed by one or more virtual machines implemented in one or more virtual environments 600 hosted by one or more of hardware nodes 630. Further, in embodiments in which the virtual node is not a radio access node or does not require radio connectivity (e.g., a core network node), then the network node may be entirely virtualized.

The functions may be implemented by one or more applications 620 (which may alternatively be called software instances, virtual appliances, network functions, virtual nodes, virtual network functions, etc.) operative to implement some of the features, functions, and/or benefits of some of the embodiments disclosed herein. Applications 620 are run in virtualization environment 600 which provides hardware 630 comprising processing circuitry 660 and memory 690. Memory 690 contains instructions 695 executable by processing circuitry 660 whereby application 620 is operative to provide one or more of the features, benefits, and/or functions disclosed herein.

Virtualization environment 600, comprises general-purpose or special-purpose network hardware devices 630 comprising a set of one or more processors or processing circuitry 660, which may be commercial off-the-shelf (COTS) processors, dedicated Application Specific Integrated Circuits (ASICs), or any other type of processing circuitry including digital or analog hardware components or special purpose processors. Each hardware device may comprise memory 690-1 which may be non-persistent memory for temporarily storing instructions 695 or software executed by processing circuitry 660. Each hardware device may comprise one or more network interface controllers (NICs) 670, also known as network interface cards, which include physical network interface 680. Each hardware device may also include non-transitory, persistent, machine-readable storage media 690-2 having stored therein software 695 and/or instructions executable by processing circuitry 660. Software 695 may include any type of software including software for instantiating one or more virtualization layers 650 (also referred to as hypervisors), software to execute virtual machines 640 as well as software allowing it to execute functions, features and/or benefits described in relation with some embodiments described herein.

Virtual machines 640, comprise virtual processing, virtual memory, virtual networking or interface and virtual storage, and may be run by a corresponding virtualization layer 650 or hypervisor. Different embodiments of the instance of virtual appliance 620 may be implemented on one or more of virtual machines 640, and the implementations may be made in different ways.

During operation, processing circuitry 660 executes software 695 to instantiate the hypervisor or virtualization layer 650, which may sometimes be referred to as a virtual machine monitor (VMM). Virtualization layer 650 may present a virtual operating platform that appears like networking hardware to virtual machine 640.

As shown in FIG. 6, hardware 630 may be a standalone network node with generic or specific components. Hardware 630 may comprise antenna 6225 and may implement some functions via virtualization. Alternatively, hardware 630 may be part of a larger cluster of hardware (e.g. such as in a data center or customer premise equipment (CPE)) where many hardware nodes work together and are managed via management and orchestration (MANO) 6100, which, among others, oversees lifecycle management of applications 620.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 640 may be a software implementation of a physical machine that runs programs as if they were executing on a physical, non-virtualized machine. Each of virtual machines 640, and that part of hardware 630 that executes that virtual machine, be it hardware dedicated to that virtual machine and/or hardware shared by that virtual machine with others of the virtual machines 640, forms a separate virtual network elements (VNE).

Still in the context of NFV, Virtual Network Function (VNF) is responsible for handling specific network functions that run in one or more virtual machines 640 on top of hardware networking infrastructure 630 and corresponds to application 620 in FIG. 6.

In some embodiments, one or more radio units 6200 that each include one or more transmitters 6220 and one or more receivers 6210 may be coupled to one or more antennas 6225. Radio units 6200 may communicate directly with hardware nodes 630 via one or more appropriate network interfaces and may be used in combination with the virtual components to provide a virtual node with radio capabilities, such as a radio access node or a base station.

In some embodiments, some signalling can be effected with the use of control system 6230 which may alternatively be used for communication between the hardware nodes 630 and radio units 6200.

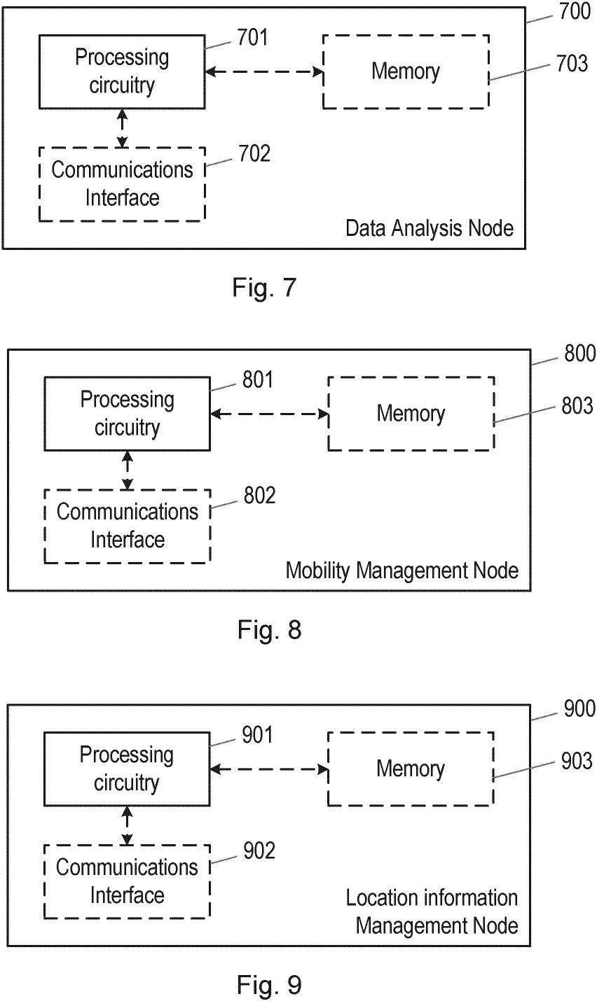

FIG. 7 is a block diagram of a data analysis node 701 according to various embodiments that can be used to implement the techniques described herein. It will be appreciated that the data analysis node 701 may comprise one or more virtual machines running different software and/or processes. The data analysis node 701 may therefore comprise one or more servers, switches and/or storage devices and/or may comprise cloud computing infrastructure that runs the software and/or processes. In a 5G network the data analysis node 701 may be a NWDAF.

The processing circuitry 702 controls the operation of the data analysis node 701 and can implement the methods described herein in relation to the data analysis node 701. The processing circuitry 702 can comprise one or more processors, processing units, multi-core processors or modules that are configured or programmed to control the data analysis node 701 in the manner described herein. In particular implementations, the processing circuitry 702 can comprise a plurality of software and/or hardware modules that are each configured to perform, or are for performing, individual or multiple steps of the method described herein in relation to the data analysis node 701.

In some embodiments, the data analysis node 701 may optionally comprise a communications interface 703. The communications interface 703 can be for use in communicating with other nodes, such as other virtual nodes. For example, the communications interface 703 can be configured to transmit to and/or receive from other nodes or network functions requests, resources, information, data, signals, or similar. The processing circuitry 702 may be configured to control the communications interface 703 of the data analysis node 701 to transmit to and/or receive from other nodes or network functions requests, resources, information, data, signals, or similar.

Optionally, the data analysis node 701 may comprise a memory 704. In some embodiments, the memory 704 can be configured to store program code that can be executed by the processing circuitry 702 to perform the method described herein in relation to the data analysis node 701. Alternatively or in addition, the memory 704 can be configured to store any requests, resources, information, data, signals, or similar that are described herein. The processing circuitry 702 may be configured to control the memory 704 to store any requests, resources, information, data, signals, or similar that are described herein.

FIG. 8 is a block diagram of a mobility management node 801 according to various embodiments that can be used to implement the techniques described herein. It will be appreciated that the mobility management node 801 may comprise one or more virtual machines running different software and/or processes. The mobility management node 801 may therefore comprise one or more servers, switches and/or storage devices and/or may comprise cloud computing infrastructure that runs the software and/or processes. In a 5G network the mobility management node 801 may be an AMF.

The processing circuitry 802 controls the operation of the mobility management node 801 and can implement the methods described herein in relation to the mobility management node 801. The processing circuitry 802 can comprise one or more processors, processing units, multi-core processors or modules that are configured or programmed to control the mobility management node 801 in the manner described herein. In particular implementations, the processing circuitry 802 can comprise a plurality of software and/or hardware modules that are each configured to perform, or are for performing, individual or multiple steps of the method described herein in relation to the mobility management node 801.

In some embodiments, the mobility management node 801 may optionally comprise a communications interface 803. The communications interface 803 can be for use in communicating with other nodes, such as other virtual nodes. For example, the communications interface 803 can be configured to transmit to and/or receive from other nodes or network functions requests, resources, information, data, signals, or similar. The processing circuitry 802 may be configured to control the communications interface 803 of the mobility management node 801 to transmit to and/or receive from other nodes or network functions requests, resources, information, data, signals, or similar.

Optionally, the mobility management node 801 may comprise a memory 804. In some embodiments, the memory 804 can be configured to store program code that can be executed by the processing circuitry 802 to perform the method described herein in relation to the mobility management node 801. Alternatively or in addition, the memory 804 can be configured to store any requests, resources, information, data, signals, or similar that are described herein. The processing circuitry 802 may be configured to control the memory 804 to store any requests, resources, information, data, signals, or similar that are described herein.

FIG. 9 is a block diagram of a location information management node 901 according to various embodiments that can be used to implement the techniques described herein. It will be appreciated that the location information management node 901 may comprise one or more virtual machines running different software and/or processes. The location information management node 901 may therefore comprise one or more servers, switches and/or storage devices and/or may comprise cloud computing infrastructure that runs the software and/or processes. In a 5G network the location information management node 901 may be an AMF.

The processing circuitry 902 controls the operation of the location information management node 901 and can implement the methods described herein in relation to the location information management node 901. The processing circuitry 902 can comprise one or more processors, processing units, multi-core processors or modules that are configured or programmed to control the location information management node 901 in the manner described herein. In particular implementations, the processing circuitry 902 can comprise a plurality of software and/or hardware modules that are each configured to perform, or are for performing, individual or multiple steps of the method described herein in relation to the location information management node 901.

In some embodiments, the location information management node 901 may optionally comprise a communications interface 903. The communications interface 903 can be for use in communicating with other nodes, such as other virtual nodes. For example, the communications interface 903 can be configured to transmit to and/or receive from other nodes or network functions requests, resources, information, data, signals, or similar. The processing circuitry 902 may be configured to control the communications interface 903 of the location information management node 901 to transmit to and/or receive from other nodes or network functions requests, resources, information, data, signals, or similar.

Optionally, the location information management node 901 may comprise a memory 904. In some embodiments, the memory 904 can be configured to store program code that can be executed by the processing circuitry 902 to perform the method described herein in relation to the location information management node 901. Alternatively or in addition, the memory 904 can be configured to store any requests, resources, information, data, signals, or similar that are described herein. The processing circuitry 902 may be configured to control the memory 904 to store any requests, resources, information, data, signals, or similar that are described herein.

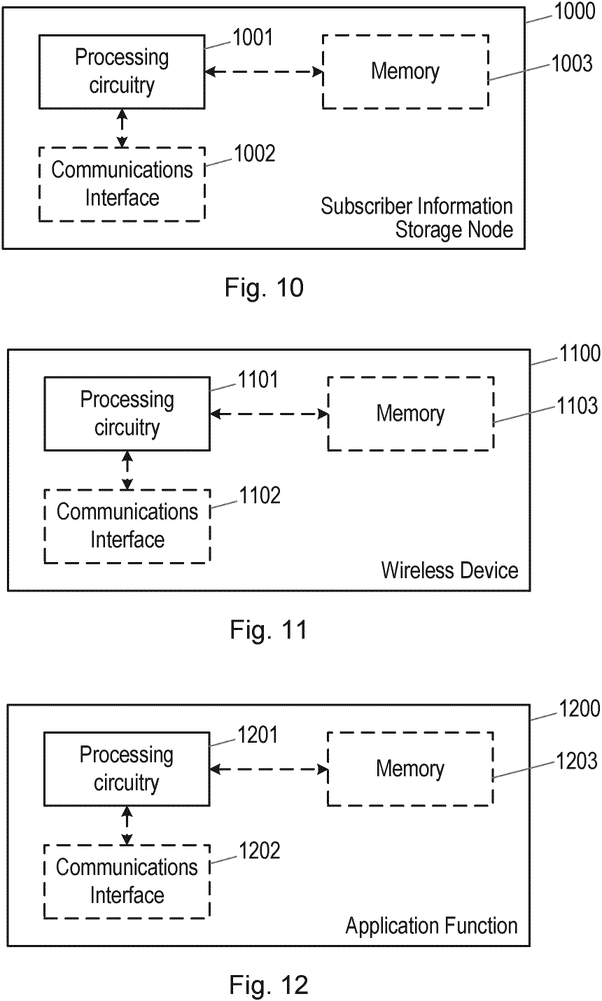

FIG. 10 is a block diagram of a subscriber information storage node 1001 according to various embodiments that can be used to implement the techniques described herein. It will be appreciated that the subscriber information storage node 1001 may comprise one or more virtual machines running different software and/or processes. The subscriber information storage node 1001 may therefore comprise one or more servers, switches and/or storage devices and/or may comprise cloud computing infrastructure that runs the software and/or processes. In a 5G network the subscriber information storage node 1001 may be a UDR.

The processing circuitry 1002 controls the operation of the subscriber information storage node 1001 and can implement the methods described herein in relation to the subscriber information storage node 1001. The processing circuitry 1002 can comprise one or more processors, processing units, multi-core processors or modules that are configured or programmed to control the subscriber information storage node 1001 in the manner described herein. In particular implementations, the processing circuitry 1002 can comprise a plurality of software and/or hardware modules that are each configured to perform, or are for performing, individual or multiple steps of the method described herein in relation to the subscriber information storage node 1001.

In some embodiments, the subscriber information storage node 1001 may optionally comprise a communications interface 1003. The communications interface 1003 can be for use in communicating with other nodes, such as other virtual nodes. For example, the communications interface 1003 can be configured to transmit to and/or receive from other nodes or network functions requests, resources, information, data, signals, or similar. The processing circuitry 1002 may be configured to control the communications interface 1003 of the subscriber information storage node 1001 to transmit to and/or receive from other nodes or network functions requests, resources, information, data, signals, or similar.

Optionally, the subscriber information storage node 1001 may comprise a memory 1004. In some embodiments, the memory 1004 can be configured to store program code that can be executed by the processing circuitry 1002 to perform the method described herein in relation to the subscriber information storage node 1001. Alternatively or in addition, the memory 1004 can be configured to store any requests, resources, information, data, signals, or similar that are described herein. The processing circuitry 1002 may be configured to control the memory 1004 to store any requests, resources, information, data, signals, or similar that are described herein.

FIG. 11 is a block diagram of a wireless device 1101 according to various embodiments that can be used to implement the techniques described herein. It will be appreciated that the wireless device 1101 may comprise one or more virtual machines running different software and/or processes. The wireless device 1101 may therefore comprise one or more servers, switches and/or storage devices and/or may comprise cloud computing infrastructure that runs the software and/or processes. In a 5G network the wireless device 1101 may be a UE.

The processing circuitry 1102 controls the operation of the wireless device 1101 and can implement the methods described herein in relation to the wireless device 1101. The processing circuitry 1102 can comprise one or more processors, processing units, multi-core processors or modules that are configured or programmed to control the wireless device 1101 in the manner described herein. In particular implementations, the processing circuitry 1102 can comprise a plurality of software and/or hardware modules that are each configured to perform, or are for performing, individual or multiple steps of the method described herein in relation to the wireless device 1101.

In some embodiments, the wireless device 1101 may optionally comprise a communications interface 1103. The communications interface 1103 can be for use in communicating with other nodes, such as other virtual nodes. For example, the communications interface 1103 can be configured to transmit to and/or receive from other nodes or network functions requests, resources, information, data, signals, or similar. The processing circuitry 1102 may be configured to control the communications interface 1103 of the wireless device 1101 to transmit to and/or receive from other nodes or network functions requests, resources, information, data, signals, or similar.

Optionally, the wireless device 1101 may comprise a memory 1104. In some embodiments, the memory 1104 can be configured to store program code that can be executed by the processing circuitry 1102 to perform the method described herein in relation to the wireless device 1101. Alternatively or in addition, the memory 1104 can be configured to store any requests, resources, information, data, signals, or similar that are described herein. The processing circuitry 1102 may be configured to control the memory 1104 to store any requests, resources, information, data, signals, or similar that are described herein.

FIG. 12 is a block diagram of an application function 1201 according to various embodiments that can be used to implement the techniques described herein. It will be appreciated that the application function 1201 may comprise one or more virtual machines running different software and/or processes. The application function 1201 may therefore comprise one or more servers, switches and/or storage devices and/or may comprise cloud computing infrastructure that runs the software and/or processes.

The processing circuitry 1202 controls the operation of the application function 1201 and can implement the methods described herein in relation to the application function 1201. The processing circuitry 1202 can comprise one or more processors, processing units, multi-core processors or modules that are configured or programmed to control the application function 1201 in the manner described herein. In particular implementations, the processing circuitry 1202 can comprise a plurality of software and/or hardware modules that are each configured to perform, or are for performing, individual or multiple steps of the method described herein in relation to the application function 1201.

In some embodiments, the application function 1201 may optionally comprise a communications interface 1203. The communications interface 1203 can be for use in communicating with other nodes, such as other virtual nodes. For example, the communications interface 1203 can be configured to transmit to and/or receive from other nodes or network functions requests, resources, information, data, signals, or similar. The processing circuitry 1202 may be configured to control the communications interface 1203 of the application function 1201 to transmit to and/or receive from other nodes or network functions requests, resources, information, data, signals, or similar.

Optionally, the application function 1201 may comprise a memory 1204. In some embodiments, the memory 1204 can be configured to store program code that can be executed by the processing circuitry 1202 to perform the method described herein in relation to the application function 1201. Alternatively or in addition, the memory 1204 can be configured to store any requests, resources, information, data, signals, or similar that are described herein. The processing circuitry 1202 may be configured to control the memory 1204 to store any requests, resources, information, data, signals, or similar that are described herein.

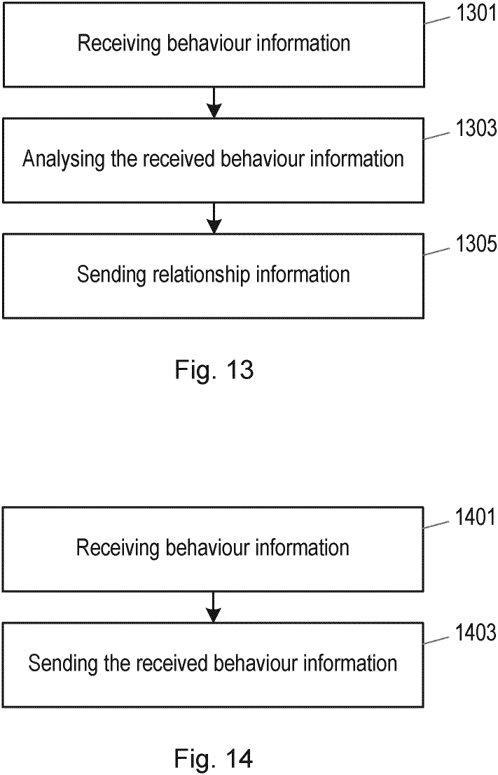

FIG. 13 is a flow chart illustrating a method of operating a data analysis node according to various embodiments. The data analysis node may be a NWDAF. In step 1301, the data analysis node receives behaviour information relating to an operational state and/or configuration of the first wireless device, and a request for information identifying wireless devices that have a relationship with the first wireless device. The behaviour information and the request are received from a location information management node in the communication network. The location information management node may be an AMF.

The behaviour information for the first wireless device may comprise any one or more of: mobility information for the first wireless device; Location Service information; UE availability; UE Location Area; UE Periodic Location; UE motion; configuration information; UE state; UE mode; capabilities of the first wireless device; battery capability; radio capability; computational capability; interaction information; and data session-related information. In some embodiments, the interaction information relates to interactions between the first wireless device and one or more other wireless devices.

In step 1303 the data analysis node analyses the received behaviour information for the first wireless device and behaviour information for the one or more other wireless devices to identify one or more wireless devices that have a relationship with the first wireless device. In some embodiments, the behaviour information for the one or more other wireless devices may comprise similar types of information as the behaviour information for the first wireless device.

In some embodiments, step 1303 comprises identifying relationships where the behaviour, data session(s) and/or configuration of the one or more wireless devices represented by the respective behaviour information has one or more similarities with the behaviour, data session(s) and/or configuration of the first wireless device represented by the behaviour information for the first wireless device.

In some embodiments, step 1303 is performed using a machine learning algorithm. The received behaviour information and the behaviour information for one or more other wireless devices are provided as inputs to the machine learning algorithm, and the algorithm analyses the input behaviour information to determine measures of similarity between the behaviour information for the first wireless device and the behaviour information for the one or more other wireless devices. The algorithm can identify one or more wireless devices that have a relationship with the first wireless device as the wireless device(s) for which the respective behaviour information has a required measure of similarity with the received behaviour information. The required measure of similarity may be any measure of similarity that is above a threshold value, the highest measure of similarity, the N highest measures of similarity (where N is some defined number), or a combination thereof.

In some embodiments, the machine learning algorithm is a graph-based machine learning algorithm. In this case, the behaviour information is input in the form of respective graphs, and the graph-based machine learning algorithm determines the measures of similarity by encoding each graph into a respective vector and comparing the vectors.

In step 1305, the data analysis node outputs relationship information comprising an identity of the one or more wireless devices that are identified as having a relationship with the first wireless device. The data analysis node sends this relationship information to the location information management node.

In some embodiments, the relationship information determined in step 1303 and sent in step 1305 comprises an indication of a type of relationship (e.g. a ranking) for each of the one or more wireless devices that are identified as having a relationship with the first wireless device.

FIG. 14 is a flow chart illustrating a method of operating a mobility management node according to various embodiments. The mobility management node may be an AMF. In step 1401, the mobility management node receives behaviour information relating to an operational state and/or configuration of a first wireless device. The behaviour information is received from the first wireless device.

The behaviour information for the first wireless device may comprise any one or more of: mobility information for the first wireless device; Location Service information; UE availability; UE Location Area; UE Periodic Location; UE motion; configuration information; UE state; UE mode; capabilities of the first wireless device; battery capability; radio capability; computational capability; interaction information; and data session-related information. In some embodiments, the interaction information relates to interactions between the first wireless device and one or more other wireless devices.

In step 1403, the mobility management node sends the received behaviour information to a location information management node in the communication network. The location information management node may be an LMF.

In some embodiments, the method can further include a step in which an indication is received from the location information management node. The indication indicates that one or more wireless devices that have a relationship with the first wireless device have been identified.

In some embodiments, the method further includes a step in which an indication is sent to the first wireless device. The indication indicates that one or more wireless devices that have a relationship with the first wireless device have been identified.

In some embodiments, the mobility management node further receives an indication of an interaction event by the first wireless device with another wireless device. This indication is received from the first wireless device. The interaction event may be a ‘Friend Interaction Event’ (FIE).

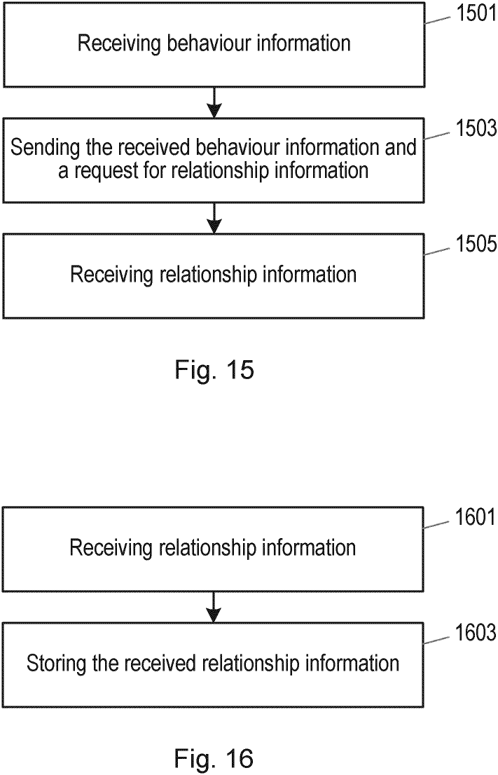

FIG. 15 is a flow chart illustrating a method of operating a location information management node according to various embodiments. The location information management node may be a LMF. In step 1501, the location information management node receives behaviour information relating to an operational state and/or configuration of a first wireless device. This behaviour information is received from a mobility management node (e.g. an AMF) in the communication network.

The behaviour information for the first wireless device may comprise any one or more of: mobility information for the first wireless device; Location Service information; UE availability; UE Location Area; UE Periodic Location; UE motion; configuration information; UE state; UE mode; capabilities of the first wireless device; battery capability; radio capability; computational capability; interaction information; and data session-related information. In some embodiments, the interaction information relates to interactions between the first wireless device and one or more other wireless devices.

In step 1503, the location information management node sends the received behaviour information and a request for relationship information identifying wireless devices that have a relationship with the first wireless device to a data analysis node (e.g. a NWDAF) in the communication network.

In step 1505, the location information management node receives relationship information comprising an identity of the one or more wireless devices that are identified as having a relationship with the first wireless device from the data analysis node. In some embodiments, the relationship information comprises an indication of a type of relationship (e.g. a ranking) for each of the one or more wireless devices that are identified as having a relationship with the first wireless device.

In some embodiments, the method further comprises the location information management node sending at least part of the received relationship information to another node for storage. The node that stores the relationship information may be a subscriber information storage node (e.g. a UDR), or the first wireless device. In some embodiments, location service privacy information relating to the first wireless device may be sent to the other node for storage.

FIG. 16 is a flow chart illustrating a method of operating a node according to various embodiments. The node may be a subscriber information storage node (e.g. a UDR) in the communication network or a first wireless device. In step 1601, the node receives relationship information comprising an identity of one or more wireless devices that are identified as having a relationship with the first wireless device. The relationship information is received from a location information management node (e.g. a LMF) in the communication network.

In some embodiments, the relationship information comprises an indication of a type of relationship (e.g. a ranking) for each of the one or more wireless devices that are identified as having a relationship with the first wireless device.

In step 1603, the node stores the received relationship information with user information for the first wireless device.

In some embodiments, the node receives, from the location information management node, location service privacy information relating to the first wireless device. The node can store the received location service privacy information.

In some embodiments, the method by the node can further comprise receiving a request for relationship information for the first wireless device. This request can be received from the location information management node. The node can send relationship information for the first wireless device to the location information management node. The relationship information may comprise the identity of the one or more wireless devices that are identified as having a relationship with a first wireless device.

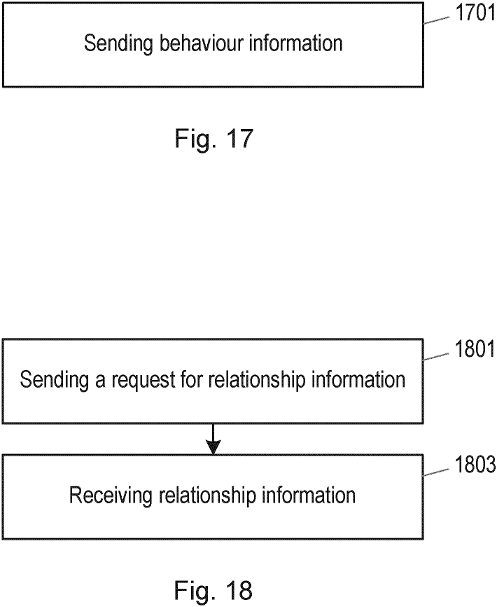

FIG. 17 is a flow chart illustrating a method of operating a wireless device according to various embodiments. In step 1701, the wireless device sends behaviour information relating to an operational state and/or configuration of the wireless device to a mobility management node in a communication network. The mobility management node may be an AMF. The behaviour information for the wireless device may comprise any one or more of: mobility information for the wireless device; Location Service information; UE availability; UE Location Area; UE Periodic Location; UE motion; configuration information; UE state; UE mode; capabilities of the wireless device; battery capability; radio capability; computational capability; interaction information; and data session-related information. In some embodiments, the interaction information relates to interactions between the wireless device and one or more other wireless devices.

In some embodiments, the wireless device may receive (from the mobility management node) an indication that one or more wireless devices that have a relationship with the first wireless device have been identified. In some embodiments, the indication may further comprise an indication of a type of relationship (e.g. a ranking) for each of the one or more wireless devices that are identified as having a relationship with the first wireless device.

FIG. 18 is a flow chart illustrating a method of operating an application function (AF) according to various embodiments. In step 1801 the AF sends a request for relationship information relating to a first wireless device to a location information management node (e.g. an LMF).In step 1803, the AF receives relationship information relating to the first wireless device from the location information management node. The relationship information comprises an identity of one or more wireless devices that have a relationship with the first wireless device.

In some embodiments, the_method further comprises providing an application service to the first wireless device and/or the one or more wireless devices that have a relationship with the first wireless device based on the received relationship information.

In some embodiments, the relationship information further comprises an indication of a type of relationship (e.g. a ranking) for each of the one or more wireless devices that are identified as having a relationship with the first wireless device.

In some embodiments, the method further comprises sending a request for location-related information for the first wireless device to a network exposure function in the communication network. The request for relationship information sent in step 1801 is sent in response to authorisation from the network exposure function.

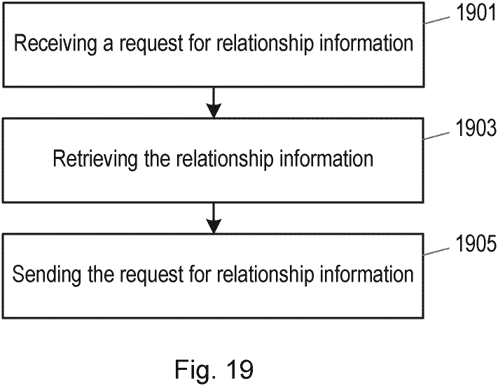

FIG. 19 is a flow chart illustrating a method of operating a location information management node according to various further embodiments. The location information management node may be a LMF. In step 1901, the location information management node receives a request for relationship information relating to a first wireless device from an application function node in the communication network.

In step 1903, the location information management node retrieves the relationship information from a storage location. The relationship information comprises an identity of one or more wireless devices that have a relationship with the first wireless device. The storage location may be a subscriber information storage node, such as a UDR, or the first wireless device.

In step 1905, the location information management node sends relationship information relating to the first wireless device to the application function node.

In some embodiments, the relationship information further comprises an indication of a type of relationship for each of the one or more wireless devices that are identified as having a relationship with the first wireless device.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1-88. (canceled)

89. A data analysis node for use in a communication network, the data analysis node comprises a processor and a memory, said memory containing instructions executable by said processor whereby said data analysis node is operative to:
receive, from a location information management node in the communication network, behavior information relating to an operational state and/or configuration of a first wireless device, and a request for information identifying wireless devices that have a relationship with the first wireless device;
analyze the received behavior information for the first wireless device and behavior information for one or more other wireless devices to identify one or more wireless devices that have a relationship with the first wireless device; and
send, to the location information management node, relationship information comprising an identity of the one or more wireless devices that are identified as having a relationship with the first wireless device.

90. A data analysis node as claimed in claim 89, wherein the relationship information further comprises an indication of a type of relationship for each of the one or more wireless devices that are identified as having a relationship with the first wireless device.

91. A data analysis node as claimed in claim 89, wherein the behavior information for the first wireless device comprises any one or more of:
mobility information for the first wireless device; Location Service information; UE availability; UE Location Area; UE Periodic Location; UE motion; configuration information; UE state; UE mode; capabilities of the first wireless device; battery capability; radio capability; computational capability; interaction information; and data session-related information.

92. A data analysis node as claimed in claim 91, wherein the interaction information relates to interactions between the first wireless device and one or more other wireless devices.

93. A data analysis node as claimed in claim 89, wherein the data analysis node is operative to analyze by identifying one or more wireless devices that have a relationship with the first wireless device as one or more wireless devices for which the behavior, data session(s) and/or configuration of the one or more wireless devices represented by the respective behavior information has one or more similarities with the behavior, data session(s) and/or configuration of the first wireless device represented by the received behavior information for the first wireless device.

94. A data analysis node as claimed in claim 89, wherein the data analysis node is operative to analyze by using a machine learning algorithm to which the received behavior information and the behavior information for one or more other wireless devices are provided as inputs, the machine learning algorithm analyzing the input behavior information to determine measures of similarity between the received behavior information and the behavior information for the one or more other wireless devices, and the machine learning algorithm identifying one or more wireless devices that have a relationship with the first wireless device as one or more wireless devices for which the respective behavior information has a required measure of similarity with the received behavior information.

95. A data analysis node as claimed in claim 94, wherein the machine learning algorithm is a graph-based machine learning algorithm, wherein the behavior information is input in the form of respective graphs, and the graph-based machine learning algorithm determines the measures of similarity by encoding each graph into a respective vector and comparing the vectors.

96. A data analysis node as claimed in claim 89, wherein the data analysis node is a Network Data Analytics Function, NWDAF, and/or the location information management node is a Location Management Function, LMF.

97. A mobility management node for use in a communication network, the mobility management node comprises a processor and a memory, said memory containing instructions executable by said processor whereby said mobility management node is operative to:
receive, from a first wireless device, behavior information relating to an operational state and/or configuration of the first wireless device; and
send, to a location information management node in the communication network, the received behavior information.

98. A mobility management node as claimed in claim 97, wherein the mobility management node is further operative to:
receive, from the location information management node, an indication that one or more wireless devices that have a relationship with the first wireless device have been identified.

99. A mobility management node as claimed in claim 97, wherein the mobility management node is further operative to:
send, to the first wireless device, an indication that one or more wireless devices that have a relationship with the first wireless device have been identified.

100. A mobility management node as claimed in claim 97, wherein the mobility management node is further operative to:
receive, from the first wireless device, an indication of an interaction event by the first wireless device with another wireless device.

101-102. (canceled)

103. A mobility management node as claimed in claim 97, wherein the mobility management node is an Access and Mobility Management Function, AMF, and/or the location information management node is a Location Management Function, LMF.

104. A location information management node for use in a communication network, the location information management node comprises a processor and a memory, said memory containing instructions executable by said processor whereby said location information management node is operative to:
receive, from a mobility management node in the communication network, behavior information relating to an operational state and/or configuration of the first wireless device;
send, to a data analysis node in the communication network, the received behavior information and a request for relationship information identifying wireless devices that have a relationship with the first wireless device; and
receive, from the data analysis node, relationship information comprising an identity of the one or more wireless devices that are identified as having a relationship with the first wireless device.

105-107. (canceled)

108. A location information management node as claimed in claim 104, wherein the location information management node is further operative to:
send at least part of the received relationship information to another node for storage.

109. A location information management node as claimed in claim 108, wherein the location information management node is further operative to:
send location service privacy information relating to the first wireless device to the another node for storage.

110. A location information management node as claimed in claim 108, wherein the node that stores the at least part of the received relationship information is a subscriber information storage node in the communication network or the first wireless device.

111. A location information management node as claimed in claim 104, wherein any of: the location information management node is a Location Management Function, LMF, the mobility management node is an Access and Mobility Management Function, AMF, and the data analysis node is a Network Data Analytics Function, NWDAF.

112-117. (canceled)

118. A first wireless device, the first wireless device comprises a processor and a memory, said memory containing instructions executable by said processor whereby said first wireless device is operative to:
send, to a mobility management node in a communication network, behavior information relating to an operational state and/or configuration of the first wireless device.

119. A first wireless device as claimed in claim 118, wherein the first wireless device is further operative to:
receive, from the mobility management node, an indication that one or more wireless devices that have a relationship with the first wireless device have been identified.

120-131. (canceled)
